(19) United States
(12) Patent Application Publication
(10) Pub. No.: US 2026/0213678 A1
(43) Pub. Date: Jul. 23, 2026

(54) COMPACT LINEAR ELECTROSTATIC CLUTCH

(71) Applicant: ESTAT Actuation, Inc., Pittsburgh, PA (US)

(72) Inventors: Kirby A. Witte, Pittsburgh, PA (US); Stuart B. Diller, Pittsburgh, PA (US); Jaiden Napier, Pittsburgh, PA (US); Nicholas Chermak, Pittsburgh, PA (US); Seema Kamath, Pittsburgh, PA (US)

(73) Assignee: ESTAT Actuation, Inc., Pittsburgh, PA (US)

(21) Appl. No.: 19/139,679

(22) PCT Filed: Dec. 18, 2023
(86) PCT No.: PCT/US2023/084681

§ 371 Date: Jun. 16, 2025

Related U.S. Application Data
(60) Provisional application No. 63/433,125, filed on Dec. 16, 2022.

(51) Int. Cl. H02N 13/00

(52) U.S. Cl. CPC H02N 13/00

(57) ABSTRACT

An electrostatic clutch comprising: a first electrode; a second electrode; a dielectric material disposed between the first electrode and the second electrode; an input connection member associated with at least one of the first electrode and the second electrode; and an output connection member associated with the second electrode or the dielectric material, wherein displacement of the input connection member relative to the output connection member does not result in a change in the overlap area of the first electrode and the second electrode.

### CROSS-REFERENCE TO RELATED APPLICATION

This application claims the benefit under 35 U.S.C. § 119 of U.S. Provisional Application Ser. No. 63/433,125, filed on Dec. 16, 2022, which is incorporated herein by reference.

### STATEMENT REGARDING FEDERALLY SPONSORED RESEARCH

This work was funded in part by Defense Health Agency SBIR Phase I project W81XWH-22-P-0039. The government has certain rights in this invention.

### BACKGROUND OF THE INVENTION

Linear clutches are used to controllably establish and break connections in applications where relative movement of components is largely constrained to linear translation. These devices are typically electromagnetic, pneumatic or hydraulic and are capable of locking the position of a linear joint or acting as a mechanical fuse to decouple drive elements such as gearing or motors from their loads. These types of devices are commonly used in heavy machinery, part fixturing in manufacturing, and in home and hospital devices such as height adjustable desks or posable beds.

Linear clutches are notably not frequently used in mobile robotics, medical robotics, aerospace, or robotic exoskeleton applications due to their size, mass, and power consumption. In these cases, motors or other actuators are used not only to achieve motion, but also to hold static loads. These static behaviors can consume large amounts of power to perform no mechanical work. In addition to motors, clutches used in linear applications are typically bulky, heavy and inefficient or require additional accessories to operate such as compressors and routed lines for hydraulic fluids or air.

While electrostatic clutches can reduce the size, mass, and power consumption required for a particular application, the length of travel of the clutch can also be an important factor. For electrostatic clutches, the overall travel of the clutch is limited by the length of the electrodes. This means that the clutch electrode length must be selected such that the overlap area of the electrodes is sufficient to transmit the loading required at maximum extension as the area of overlap between the two electrodes decreases. This also requires the fully collapsed length of the clutch to be at a minimum the sum of the length required to hold the intended load and the length of travel required. If space is limited, the collapsed length may be too long to be useful.

Linear electrostatic clutches can also be used in a rotary capacity and utilize space that is currently underutilized or even wasted in mechanical assemblies. For example, rotary joints often contain a large number of components such as bearings, encoders, motors, gear boxes, torque sensors etc. Adding additional components in line with the joint can be infeasible due to limited space or interference with the environment.

It would therefore be advantageous to develop a clutch that enables substantially constant clutch overlap area as the output or input experience travel. These features enable more compact and versatile solutions than a simple linear electrostatic clutch given a set of force and travel requirements. These types of linear clutches with shorter collapsed lengths are particularly useful in applications with limited available space typically requiring significant travel of several inches or more. This includes but is not limited to exoskeleton, mobile robotics, linear motion stages, and aerospace applications.

### BRIEF SUMMARY

According to embodiments of the present disclosure is a compact linear clutch that utilizes at least two electrodes separated by a dielectric material, where a voltage applied across the electrodes causes an electrostatic attraction. Connection mechanisms and a winding device, such as a roller, maintain a nearly constant electrode overlap area. The compact linear clutch can also maintain a shorter overall length even when moving through its travel range.

### BRIEF DESCRIPTION OF THE SEVERAL VIEWS OF THE DRAWINGS

FIG. 1 depicts an electrostatic clutch utilizing a roller to reroute an electrode associated with an output connection mechanism, according to one embodiment.

FIG. 2 shows the collapsed and extended states of a roller-based clutch.

FIG. 3 is a linear clutch utilizing a spool for electrode storage and payout.

FIG. 4 shows a linear clutch of constant length having a winding device.

FIG. 5 is a linear clutch featuring a floating roller.

FIG. 6 shows an embodiment of a linear clutch used to control resistance to a rotary joint.

FIG. 7 shows two linear clutches used antagonistically to control resistance to a rotary joint.

FIG. 8 depicts an embodiment in which the electrodes transmit force to the input and the dielectric transmits force to the output.

FIG. 9 is an embodiment utilizing an electrode shuttle with flexible housing.

FIG. 10 is an exploded view of an embodiment utilizing an electrode shuttle with flexible housing and tether attachments.

FIG. 11 is a detailed exploded view of an embodiment utilizing an electrode shuttle with flexible housing and tether attachments.

FIG. 12 is an embodiment of a clutch element in which an electrode is disposed on a belt which drives a rotary joint.

FIG. 13 shows a clutch element comprising a timing belt with teeth interposed between two flexible clutch members comprising an electrode with dielectric material disposed on its surface.

FIG. 14 shows a belt clutch member in which the electrode is disposed between two rows of timing teeth.

FIG. 15 shows an input electrode that interacts with a belt clutch element on its outer perimeter.

FIG. 16 is an embodiment of a belt clutch element including an electrode disposed on the outer perimeter of the belt's loop.

FIG. 17 shows an electrostatic clutch mounted to a linear stage to the sides of a belt.

FIG. 18 is a compact linear clutch comprising a coiled clutch element with an electrode disposed on each of its top and bottom surfaces.

FIG. 19 is a compact linear clutch comprising telescoping clutch elements.

FIG. 20 is a compact linear clutch utilizing a tether and flexible housing to enable conformable wearable devices.

### DETAILED DESCRIPTION

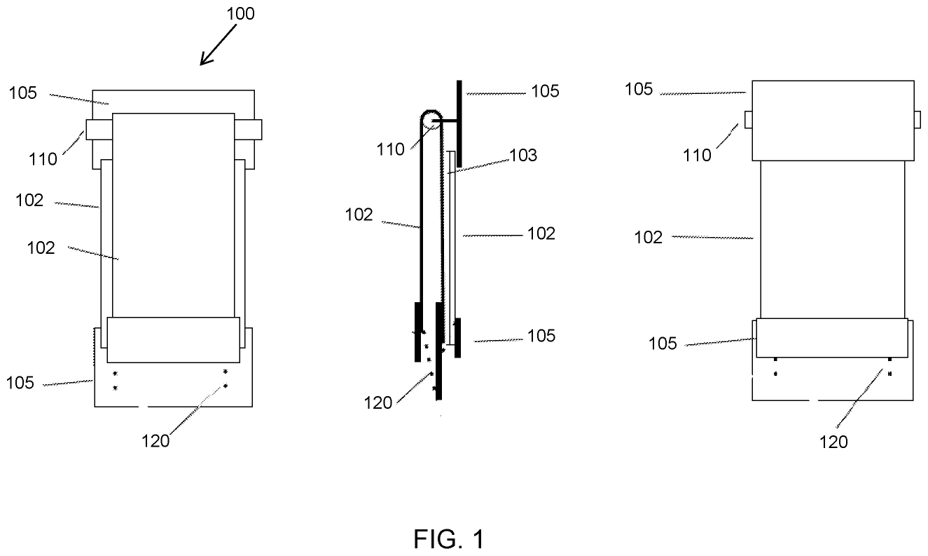

According to embodiments of the present disclosure is a compact linear clutch 100. As shown in FIG. 1, the linear clutch 100 has electrodes 102, a dielectric material 103 separating the electrodes 102, and connection members 105. In the embodiment shown in FIG. 1, a first electrode 102 is connected to an input connection member 105 and a second electrode 102 is connected to an output connection member 105. Further shown in FIG. 1 is a winding device 110, which comprises a roller in the example embodiment shown in FIG. 1. The winding device 110 may comprise a roller, spool, pulley, or similar mechanism that affects the total length or positioning of the flexible electrode 102.

A linear electrostatic clutch 100 can be used to resist motion in most devices featuring a linear degree of freedom, a rotary degree of freedom with limited range of motion, or rotary degrees of freedom in which a portion of the linear clutch 100 remains stationary relative to a belt that can travel continuously. Each clutch 100 includes at least two electrodes 102 separated by a dielectric material 103. In the off-state (i.e. no electrostatic attraction), the electrodes 102 are free to move relative to one another. In the on-state (i.e. electrostatic attraction), a voltage is applied across the electrodes 102, which causes them to adhere to one another. This behavior can be used to provide resistive loading between the input connection mechanism 105 and the output connection mechanism 105, which are the input and output stages of the clutch 100. The mechanical connections of the clutch to an external mechanical system are called the clutch input and output. These connections 105 may be achieved through bolted joints, adhesives, rivets, welds, press fits, clamps, flanged connections, threaded connections, epoxies, pressure sensitive adhesives, or other attachment methods. The standard used in this disclosure is the moving electrode 102, or clutch member, or clutch member set is considered the output, but this definition might not apply in all cases. For example, in cases where both clutch electrodes 102 or clutch members are moving, either could be defined as the input or output.

The amount of resistive loading that can be provided by the clutch 100 is controlled by the voltage applied and the area of electrode overlap. Other factors that cannot typically be changed as part of real-time control, but none-the-less affect the resistive loading are: the coefficient of friction of the materials interacting at the clutch interface, the stiffness of the clutch electrodes 102, the dielectric constant of the dielectric material 103, the thickness of the dielectric material 103 and other properties of the design and materials used. The resistive force scales with the square of the applied voltage. This relationship does not hold at very low voltages (less than 10 V) or at voltages approaching the breakdown voltage of the dielectric material 103.

The clutch 100 shown in FIG. 1 achieves smaller collapsed lengths than previous electrostatic clutch devices by storing the flexible electrodes 102 in a winding device 110, by spooling, wrapping the over rollers, by utilizing a shuttle or by clutching some portion of a traveling belt 111 or chain.

A linear clutch 100 may comprise some or all of the following elements: two or more electrodes 102, dielectric layers 103 attached to the electrodes 102 or otherwise disposed between them, structural elements or connection members 105 connecting the electrodes 102 to the input stage and output stage, tensioners 120, winding devices 110 (i.e. rollers, idlers pulleys), springs, semi-flexible reinforcing sheets, linear bearings, a housing, a dry or wet lubricant, and a circuit 170 comprising some or all of: a microcontroller, a voltage transformer, a battery, a sensor, a user interface, relays, MOSFETs, and transistors, electrical connections between the electrodes and the circuit, electrical isolation materials.

The electrodes 102 may be flexible, rigid, or semi-flexible, or a combination of any of the foregoing. In some embodiments, the electrodes 102 may be thin and disposed on a carrier, substrate, or structural member. In these cases, the entire electrode 102, or a select portion of the electrode 102 may be constrained to the carrier, substrate, or structural member. In other embodiments, the electrode 102 may serve as both electrode 102 and structural member or frame capable of transmitting mechanical load with or without additional support. Any of these configurations can be effective as long as at least one electrode 102 is flexible, semi-flexible or compliant.

For the purpose of concise description, “clutch member” is used throughout this document to describe a component or group of components capable of acting as an electrode 102 and transmitting a mechanical load resulting from electrostatic attraction between the electrodes 102 of the clutch members. A clutch member can be an electrode 102, an electrode 102 with a carrier, a rigid substrate coated with a conductive layer, etc. Clutch members may include a dielectric material 103. Clutch members may be composed solely by electrodes 102 capable of transmitting mechanical loads themselves as is the case in embodiments in which metal plates are used as both electrodes 102 and structural components. In other embodiments, clutch members comprising both electrodes 102 and reinforcing structural components may be used. Each clutch member is associated with either the input or output of the clutch 100. At least two clutch members are required for an electrostatic clutch 100 to operate. One member attaches to the mechanical input and the other attaches to the mechanical output. The clutch members may also be used in sets. In this case, a first set of clutch members is connected to the clutch's mechanical input while a second set of clutch members is connected to the clutch's mechanical output.

“Clutch interface” refers to the overlapping area of the input and output electrodes 102 over which a force of adhesion is established in the engaged state.

In several embodiments, the output clutch members and input clutch members both include electrodes 102. In these cases, the output electrode 102 and input electrode 102 are held at different voltages when in the engaged state. When disengaged, their electrodes 102 are shorted together to bring them to the same voltage potential. Electrical connections can be established via swages, clips or other conductive clamping methods, or by soldering, or via conductive adhesives. In some embodiments, a portion of the electrode 102 may be conveniently shaped to enable insertion of the electrode 102 into an electrical connector such as a card edge connector, Zero Insertion Force (ZIF) connector, or pin header. Sliding electrical connections may be used to maintain connection to moving components. These may include spring fingers, carbon brushes, wire brushes or other sliding connections. In cases where sliding electrical connections are not utilized, cables may be used instead.

Referring again to the figures, FIG. 1 shows one embodiment of a linear clutch 100 in which the output clutch member is comprised of a flexible electrode 102 connected on one end to the output base frame, or connection member 105, and on the other end to a tensioner frame, or connection member 105. In this embodiment, the output clutch member includes the flexible electrode 102. The output clutch member wraps over a roller 110 and its tensioner frame 105 is connected to the output frame 105 using one or more tensioners 120. The roller 110 is situated such that the gap between the input electrode 102 and output electrode 102 is between 0 and 0.050 inches, although the gap may vary depending on the voltage applied and intended application. The input clutch member is comprised of an input base frame, a tensioner frame and a clutch member including an electrode 102 and the dielectric material 103 coating the surface. The input electrode 102 may be flexible, rigid, or semi flexible. In other embodiments, the input clutch member, a single component may act as both electrode 102 and frame. The tensioners 120 may be rubber, elastomers, elastic cords, coil springs, torsional springs, or other deforming elements. Tension may also be maintained by suspended masses or inertial elements. In other embodiments, both of the electrodes 102 may be coated with dielectric material 103, or a separate dielectric layer 103 could exist between the electrodes 102.

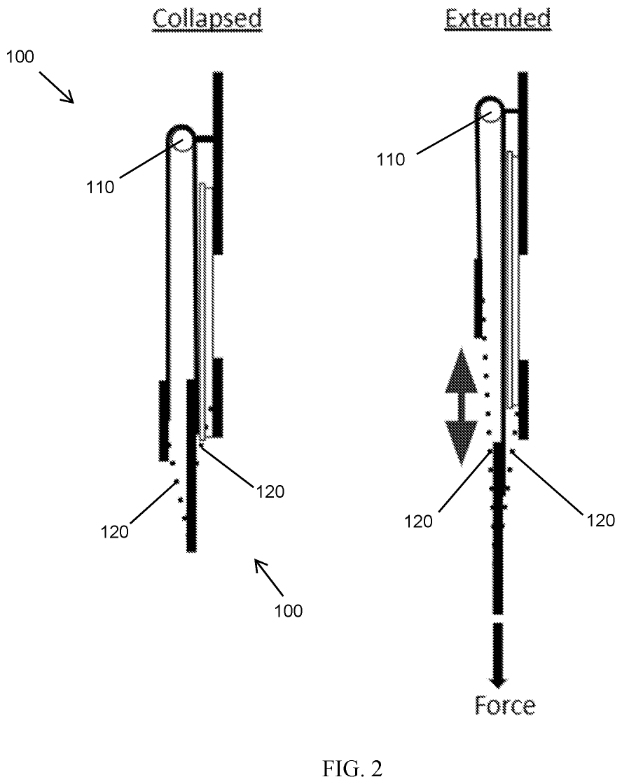

FIG. 2 shows the same embodiment as FIG. 1 and demonstrates the behavior of the clutch 100 as it collapses and extends. When the output frame displaces downward, the output clutch member rolls over the roller 110, shortening the amount of clutch area stored on the left side, but maintaining the same overlap area with the input electrode 102. The maximum extended state of the clutch 100 is constrained by the tensioner bar reaching the roller 110. The maximum travel distance of the clutch 100 while maintaining constant clutch overlap area must be less than one half of the total length of the output clutch member.

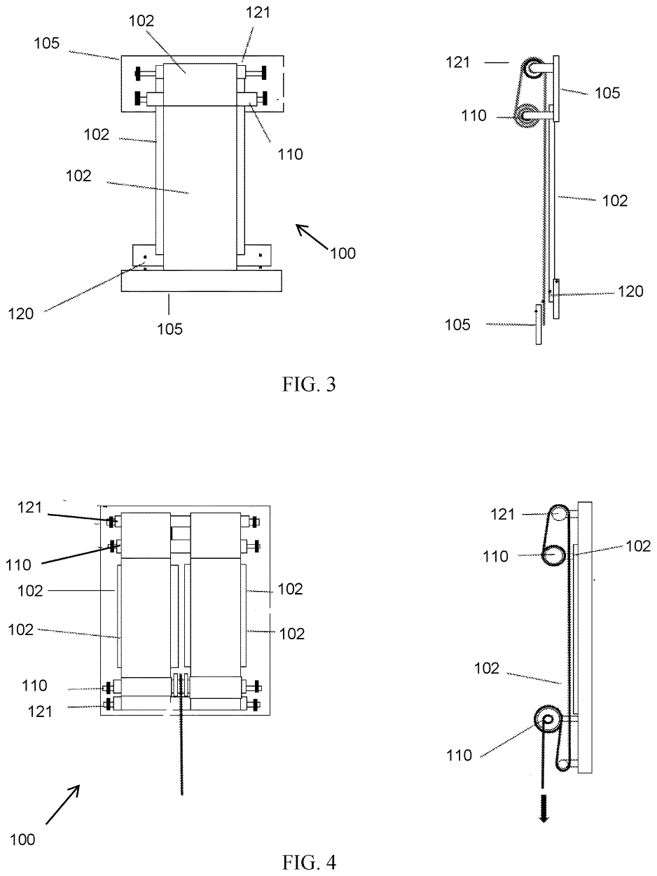

FIG. 3 shows an embodiment of the linear clutch 100 which uses a spool 110 to store excess length of the output electrode 102 to enable a reduced total length of the clutch 100 when in the retracted, collapsed state. The spool 110 comprises a cylindrical surface and a tensioning component 120. This tensioning component 120 may comprise a torsional spring, a clock spring, a linear spring acting to rotate the spool 110, an elastic spring which coils onto the spool which is terminated off of the spool. Other tensioning strategies such as hung weights or spools with off center weight may be used to apply tension to the spool 110. The depicted embodiment includes a roller 121 associated with the tensioner 120. This roller 121 should be aligned such that the gap between the output electrode 102 and the input electrode 102 is smaller than 0.050 inches. The roller 121 can maintain the constant gap, while the spool 110 changes diameter as more or less electrode length is stored. The depicted embodiment also includes a tensioner 120 connected between the output frame and input tensioner bar to maintain alignment of the input clutch member to the output clutch member.

FIG. 4 shows an embodiment of the linear clutch 100 which uses two spools 110 to store and pay out the output electrode 102 achieving a constant length of the clutch 100. The input electrode 102 is shorter than the output electrode 102 and does not spool. The spooling output electrode 102 interacts with a constant area of the input electrode 102. Both spools 110 are mounted on a base frame or within a housing. One spool 110 is a tensioning spool, the other spool 110 is the output spool. The tensioning spool 110 includes a tensioner 120 which retracts the output electrode 102 when external forces on the output are relieved and the clutch 100 is in a disengaged state. The output spool 110 may include a tensioner 120 or not. The output electrode 102 wraps on the output spool 110 and off of the tensioning spool 110 when the output cable is extended. The output electrode 102 wraps off of the output spool 110 and onto the tensioning spool 110 when the cable is retracted. An output cable wraps onto the output spool 110 such that tension in the cable is resisted by tension in the output clutch member. In this embodiment, there are two input electrodes 102 and two output electrodes 102 such that the output cable is attached in the middle of the output spool 110. Each spool 110 has an associated roller 121 to maintain a constant gap between the output clutch member and the input clutch member as the diameter of the spools 110 changes during clutch travel. Other embodiments may have more electrodes 102 or just a single pairing of an input electrode 102 and an output electrode 102 with a cable spool or capstan located to the side of the clutch interface. In some embodiments, the output may be a gear mounted to the shaft of the output spool 110 rather than an output cable as shown. The alignment rollers 121 depicted in FIG. 4 may be excluded in some embodiments.

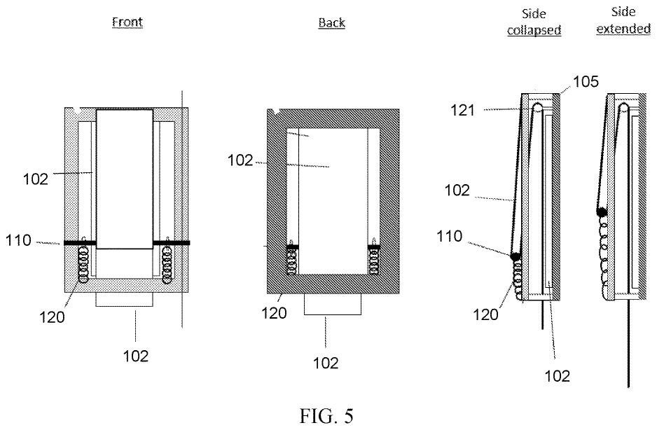

FIG. 5 shows an embodiment in which a flexible output electrode 102 is taken in and paid out in loops managed by a floating roller 110. The floating roller 110 is connected to one or more tensioners which maintain tension on the output clutch member, but allow the roller 110 to travel parallel to the direction of travel of the output electrode 102. When the clutch 100 is in the disengaged state and tension on the output is relieved, the tensioners 120 contract to increase the distance between the rollers 110 and the length of each loop of the output electrode 102. When the clutch 100 is in the disengaged state and force is applied to the output electrode 102 of magnitude great enough to extend the tensioners 120, the tensioners 120 extend and the length of each loop of the output electrode 102 is reduced. When the clutch 100 is in the engaged state, shear forces at the interface between the input and output clutch members provide resistive loading against the extension of the output clutch member. In other embodiments, multiple floating rollers 110 may be employed to create additional loops and further extend the maximum clutch travel.

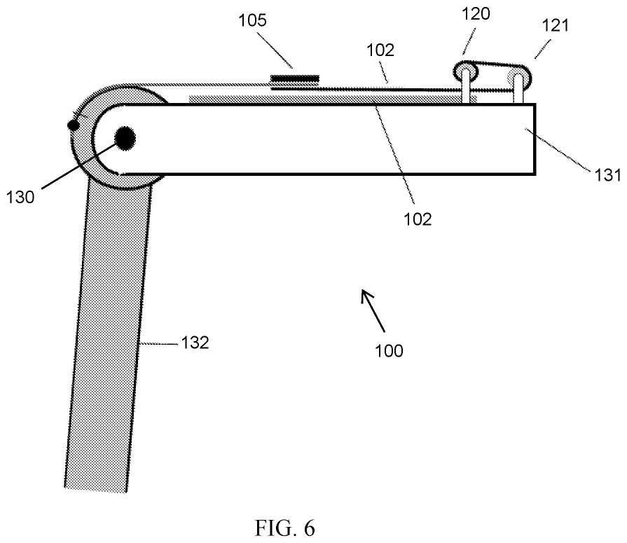

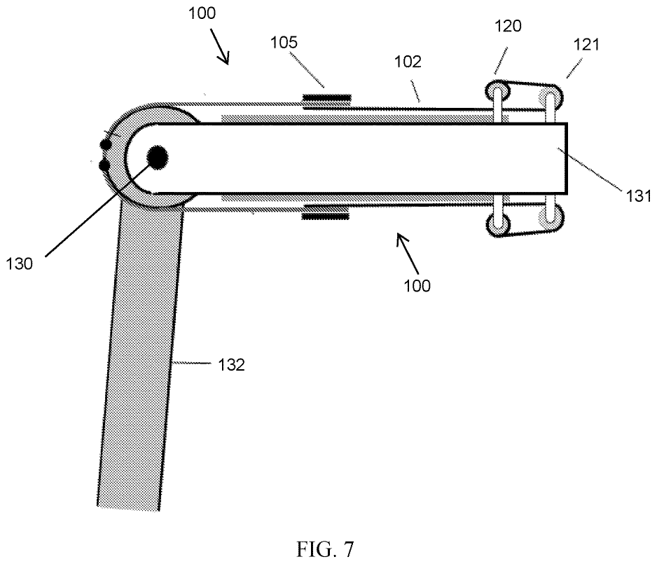

FIG. 6 shows an embodiment in which a linear clutch 100 is utilized in a rotary application. A linear clutch 100 is mounted on a first link 131 which is connected to a second link 132 through a rotary joint 130. The input electrode 102 is fixed relative to the first link 131, the output electrode 102 slides parallel to the input electrode 102 when the second link 132 rotates about the joint 130. In this embodiment, a thin electrically insulated or insulating tether is disposed on the output electrode 102 such that mechanical loads can be transmitted from the output clutch member to the tether and ultimately to the second link 132. When the clutch 100 is engaged, clockwise rotation of the second link 132 relative to the first link 131 is resisted by forces at the clutch interface. Due to the flexible nature of the tether and the output electrode 102, this configuration can be used to supply resistive loading in only a single direction. In other embodiments, a second clutch 100 and tether can be used antagonistically to provide bidirectional action as shown in FIG. 7. A linear clutch 100 comprising a tensioned spool 110 is shown for demonstration purposes. Any embodiment of a linear clutch 100 described herein may be utilized for this purpose.

In some embodiments, tensioners 120 may be rubber-based, elastic bands or cord, coil springs, torsional springs, clock springs, constant force springs, synthetic elastomers, or weighted elements. Tensioners 120 may connect between electrode frames or may be otherwise connected to the housing of the clutch or the input or output of the device utilizing the clutch 100. In some embodiments the force required to deform the tensioners 120 is smaller than the maximum force that is transmittable across the clutch interface.

The winding device 110 may comprise some or all of the following components: a cylindrical surface, center pins, plain bearings, ball bearings, needle bearings, thrust bearings, springs, pillow blocks, adjustment screws and mounting hardware. The cylindrical surfaces may have end detents, shoulders, through holes or blind holes. The roller surface may be cylindrical, convex crown, straight taper with center flat, straight taper or concave crown or other shape. The flanges may or may not be disposed at the roller ends.

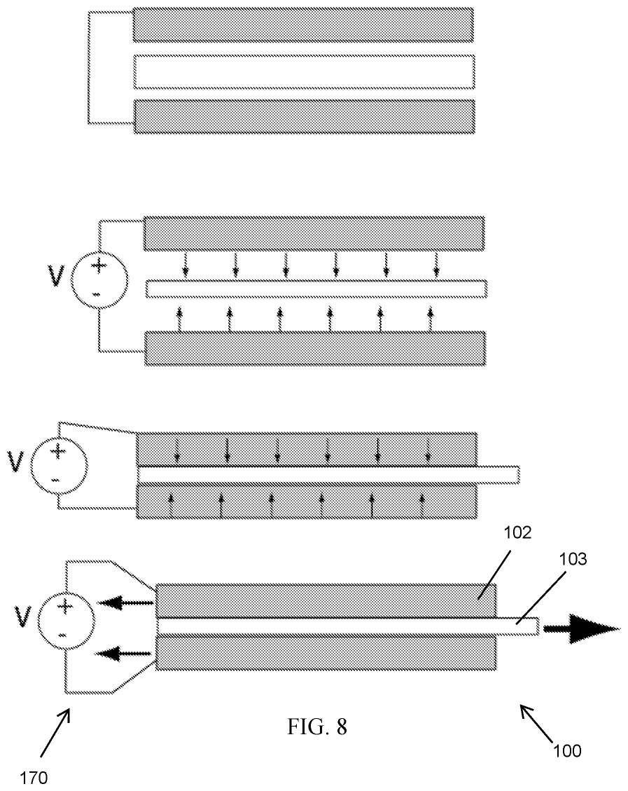

The dielectric material 103 separating the electrodes 102 may be applied to one or both electrodes 102 as a coating. The dielectric material 103 may also be interposed between the electrodes 102. FIG. 8 depicts an embodiment in which the dielectric 103 comprises one of the clutch members and transmits force to the output. In this embodiment, when voltage is applied across the electrodes 102, the electrostatic force of attraction draws the electrodes 102 together such that the dielectric material 103 in the middle is squeezed. Both electrodes 102 are connected to input. When force is applied to extend the output relative to the input when the clutch 100 has voltage applied, the friction at the two interfaces between the dielectric 103 and electrode 102 resists the force. For the same thickness of dielectric material 103, this embodiment can achieve twice the holding force experienced by embodiments in which one electrode 102 is attached to the input clutch member and one electrode 102 is attached to the output clutch member with the dielectric material 103 existing between the two electrodes 102. When there is no voltage applied across the clutch interface, the electrodes 102 experience no force of attraction.

In other embodiments, the dielectric member may include an electrode 102 that does not feature any explicit electrical connection to the circuit other than through the dielectric surfaces themselves. In this particular embodiment, the clutch 100 utilizes three electrodes 102 where the interfaces are in parallel electrically and one of the electrodes is unconnected to electrical power, which eliminates the need for a traveling electrical connection like a brush.

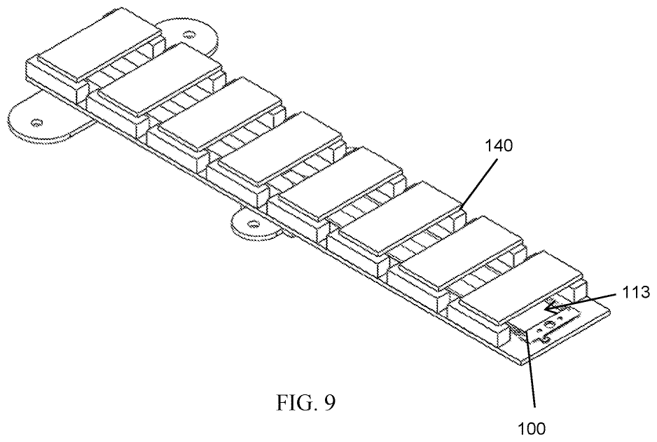

FIG. 9 shows an embodiment in which a tether is used in conjunction with an electrode shuttle 113 to reduce the overall length of the clutch 100 in the extended state as compared to a configuration without a shuttle 113. This embodiment features an output electrode 102 that is shorter than the input electrode 102. The clutch member comprising the short electrode is called a shuttle 113. In the disengaged state, the output electrode shuttle 113 travels along the length of the input electrode 102. The clutch 100 is extended when tension is applied to the tether and the output electrode 102 is retracted by two tensioners 120. A guide 141 which is disposed on the output electrode 102 with an opening which confines the input electrode 102 such that the shuttle 113 travels along the length of the input electrode 102 without significant translation perpendicular to the input electrode 102. This guide 141 may be disposed on any clutch member, or may be included as part of the clutch housing 140. This embodiment of the clutch housing 140 is flexible. The top and bottom surfaces of the enclosure are formed of flexible sheets separated by standoffs. In this embodiment, the standoffs are compressible foam. Multiple short lengths of foam line the sides of the housing 140 with breaks in between. In other embodiments the standoffs may be a single component with slits or V-shaped cuts, a single continuous component, multiple rigid components. In other embodiments the function of the standoffs may be achieved by walls of an enclosure otherwise manufactured. The housing 140 may be flexible, semi-flexible, may have unequal flexibility in different directions, or may be rigid.

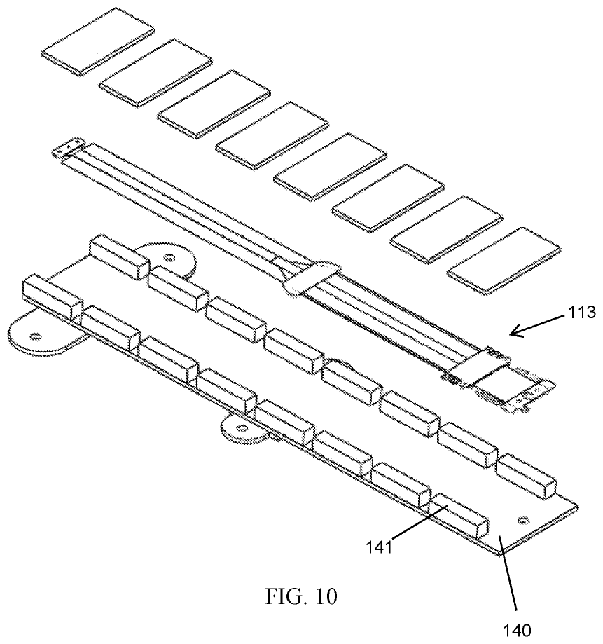

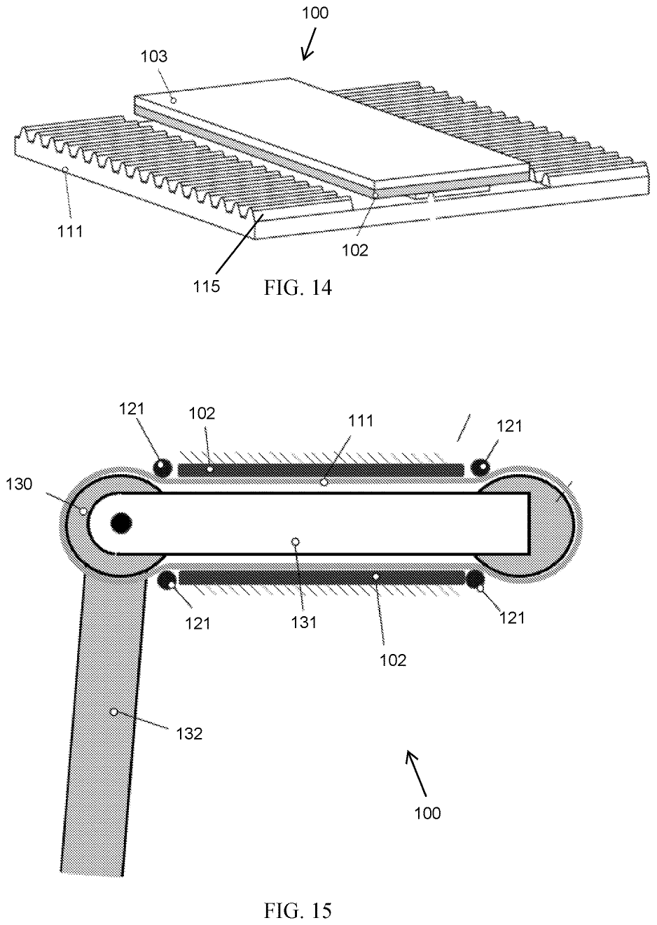

FIG. 10 shows an exploded view for further detail describing the shuttle 113 of the embodiment depicted in FIG. 9. In the embodiment shown in FIGS. 13 and 14, the shuttle 113 is comprised of two clutch members each featuring an output electrode 102. The input electrode 102 is interposed between the two output electrodes 102 and connected to the input connection member 105. Both output electrodes 102 are disposed on a polymer carrier. A small portion of the output electrode 102 is adhered to the carrier by a pressure sensitive adhesive. In this embodiment, the adhesive is applied in a single stripe down the center of the shuttle 113, but other patterns may be used. A guide 141 is comprised of four planar components adhered with pressure sensitive adhesive. This guide 141 is disposed on one of the output electrodes 102, and the input electrode 102 and second output electrode 102 are disposed within the guide 141. The advantage of the tether is having a smaller size and greater flexibility than the electrode 102, allowing it to be routed more easily to the external connection point. It also allows the area of the clutch 100 to remain the same over the full travel of the shuttle 113. Because the engage and response times of the clutch 100 can be dependent on the overlapping area, this design allows the clutch 100 to have predictable engage and response times regardless of the state of clutch extension.

Clutch elements may comprise belts as connection members 105 and may include an electrode 102. These belts may include but are not limited to friction belts, v-shaped belts and toothed belts. These belt clutch members may have a variety of constructions. The flexible electrode 102 may be comprised of a thin conductive sheet of metal or carbon fiber. In this case it may comprise both the electrode 102 and the connection member 105, or it may be attached to a frame or a carrier that acts as the connection member 105. In other embodiments the flexible electrode 102 may be disposed on a polymer carrier or may be an intrinsically conductive polymer sheet such as carbon filled polyimide or other flexible conductive element. The flexible electrode 102 may be connected to its structural frame by pressure sensitive adhesive or glue, or by clamping force achieved by bolts, screws, rivets or other connective hardware.

FIG. 11 depicts a detailed exploded view of a clutch 100. This embodiment utilizes a tether and electrode shuttle 113 comprised of an output clutch member, where the output clutch member is comprised of: output electrodes 102, adhesives, carriers, structural boards, and a rigid connectors. In this embodiment, the shuttle 113 travels along the input electrode 102 and tension is maintained by springs. In some embodiments, a thin tether may extend the length of one or both clutch members. The tether may be attached to an entire surface of an electrode 102, may attach to only a portion or may be connected to the electrodes 102 indirectly through any number of additional components such as structural frame elements. The attachment of the tether to the electrode 102 may be established by pressure sensitive adhesive, glue, tape, clamping achieved by connective hardware such as bolts, screws or rivets or by other method. A supporting structure may be disposed near the junction of the tether and the electrode 102. The length of the tether may be further extended by attachment to an additional tether element that may have characteristics dissimilar to the first portion of the tether. In some embodiments, this tether extension may be a cord, rope or cable of thickness greater than the tether elements more proximal to the output electrode 102.

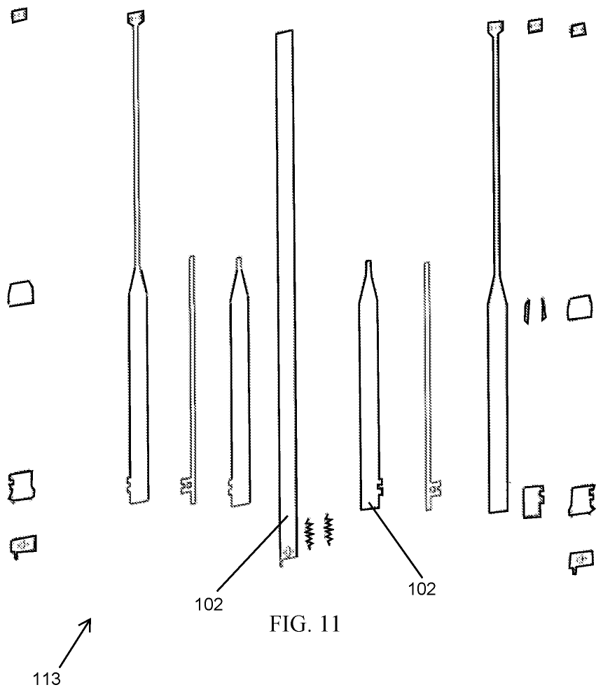

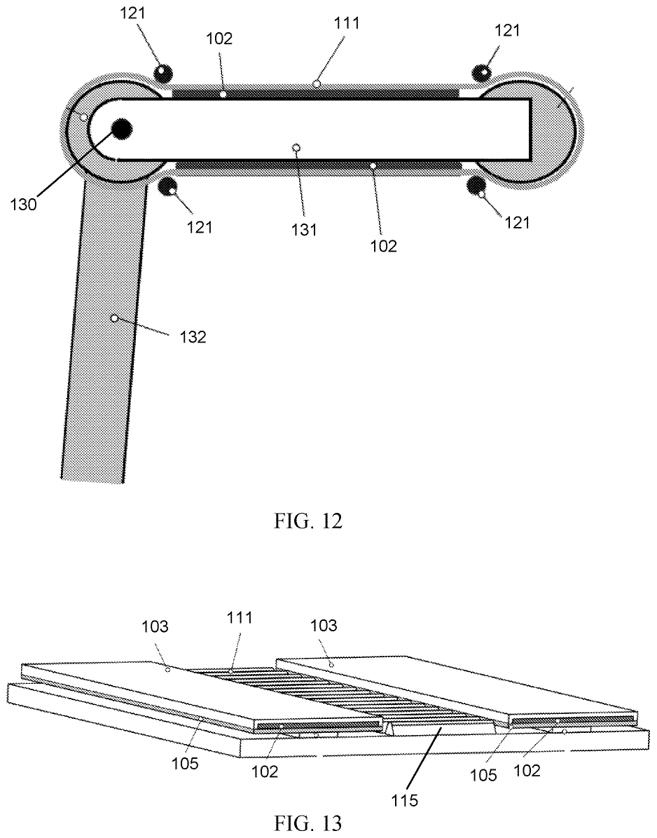

FIG. 12 depicts an embodiment of a belt based clutch member in which the electrode 102 is mounted on the inside face of a timing belt 111. The belt-mounted electrode 102 may move and deform with the belt 111. The input clutch member containing an electrode 102 is located near the inner perimeter of a loop in the belt 111 near the surface of the belt-mounted electrode 102 such that when a voltage is applied across the electrodes 102 the surfaces adhere and force can be transmitted between the stationary electrode 102 and the belt-mounted electrode 102. Any number of idlers or rollers 121 may be added to maintain the correct spacing and alignment between the clutch members.

FIG. 13 depicts an embodiment of a belt-mounted electrode 102 in which two clutch members are disposed to either side of and coplanar to timing teeth 115. The timing teeth 115 prevent slipping and maintain alignment of connected rotary parts. The flexible electrodes 102 are disposed on a flexible carrier. The flexible electrodes 102 are encapsulated by dielectric material 103.

FIG. 14 depicts an embodiment of a belt-mounted electrode 102 disposed between and coplanar with two rows of timing teeth 115.

FIG. 15 depicts an embodiment of the clutch 100 in which a stationary electrode 102 is mounted on a structure in close proximity to the belt 111. In some embodiments this structure may be a housing or belt guard. The moving electrode 102 is mounted to the outer surface of a timing belt 111, and conforms with the timing belt 111 as it moves around the pulley and cylindrical surface. In other embodiments there may be one or more stationary clutch members. These members may be straight or curved.

FIG. 16 depicts an embodiment of an output clutch member comprising a belt 111 with an electrode 102 disposed on the outer perimeter of the belt's loop opposite of the belt friction or toothed surface 112. In this embodiment the electrode 102 is disposed on a polymer carrier and is encapsulated by a dielectric material 103. The polymer carrier is disposed on the surface of the belt 111 with mechanical attachment achieved by a flexible adhesive selectively applied such that a portion of the carrier and electrode 102 experiences greater out of plane flexibility than the adhered region. In other embodiments, the polymer carrier may be attached across its whole surface, or with other patterns of adhesive. In other embodiments, the polymer may be retained on the surface of the belt 111 simply through friction or belt tension.

Belt-mounted configurations may comprise a variety of configurations. The belt 111 may comprise an electrode 102 or a flexible electrode 102 may be disposed on the belt 111. The stationary clutch member may be comprised of conductive material and act as an electrode 102, or the stationary clutch member may have an additional electrode 102 either flexibly or rigidly disposed on its surface. Any number of idlers or rollers 121 may be used to maintain alignment of the belt 111 and clutch elements. The clutch electrode 102 may be mounted on the inside or outside surface of the belt 111 or, in other embodiments, along the outer edges running perpendicular to pulley surfaces. Clutch electrodes 102 may be disposed to one side of teeth or friction surfaces 112 of the belt 111, interposed between these elements, or disposed to either side. There may be one or a plurality of clutch members disposed on the belt 111. Clutch members may be continuous along the surface of the belt 111 or may exist as one or more short segments. In some embodiments, the belt 111 may a be friction belt or V-belt. The belt 111 may comprise the clutch member, or it may have clutch members disposed to the sides of or between friction surfaces 112 of the belt 111. In some embodiments, the clutch member may serve multiple purposes as friction surface 112 or belt structure. Flexible electrodes 102 and carriers may be made of polymer films, fiberglass, rubber, plastic, or other materials.

In some embodiments, the clutch member comprises an electrode 102 selectively adhered to the belt 111 such that a portion of its surface is free to flex. In these embodiments the dielectric material 103 is disposed on the surface of the belt-mounted electrode 102 on its outer surface. In other embodiments, the electrode 102 may be fully encapsulated by the dielectric 103 and the belt 111. In other embodiments, the belt 111 itself may be constructed from conductive materials or may have a conductive coating applied to act as a dielectric 103. The dielectric 103 may be disposed on the belt side electrode 102, the stationary electrode 102, or both.

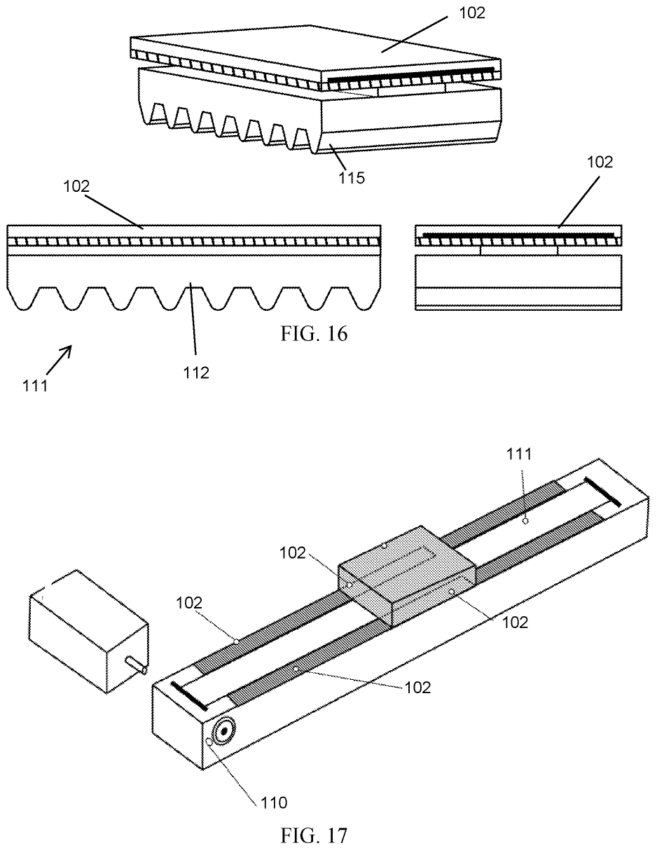

FIG. 17 depicts an embodiment of a linear clutch 102 integrated into the structure of a belt-driven linear stage. The moving electrode 102 is attached to the bottom surface of the sides of the platform or shuttle 113. The stationary electrode 102 is attached to the surface of the housing of the linear stage, such that when a voltage is applied across the electrodes 102, the platform 113 is constrained to the housing of the linear stage. In some embodiments, the surface of the housing of the linear stage itself may act as the clutch electrode 102. In other embodiments, the moving electrode 102 may be attached to the portion of the belt 111 that exists within the housing of the linear stage, and the stationary electrode 102 may be disposed on an inner surface of the housing of the linear stage housing. The moving electrode 102 may be attached to either side of the moving belt 111, and may or may not have an electrical brush that establishes an electrical connection to a non-moving portion of the actuator.

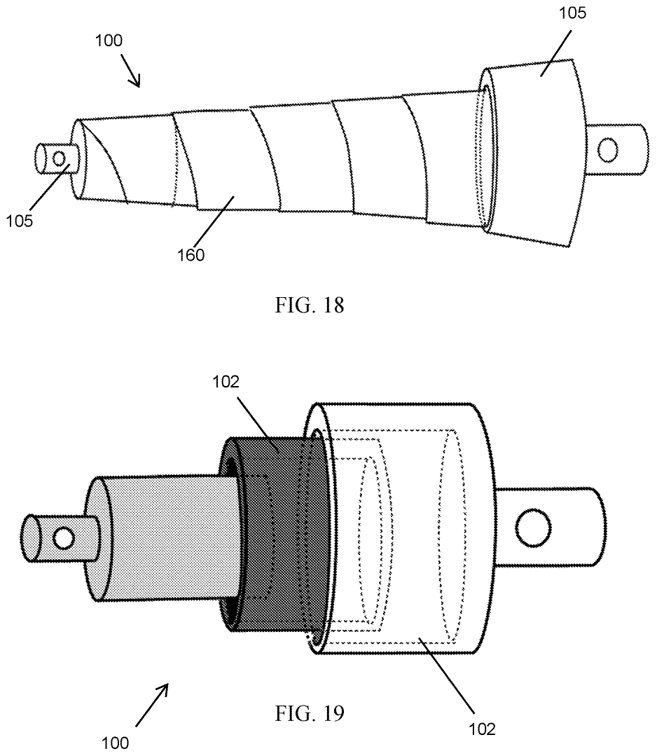

FIG. 18 shows an embodiment of the compact linear clutch 100 comprising a long flexible carrier with electrodes 102 disposed on its top and bottom surfaces. This clutch member featuring a carrier and two electrically isolated electrodes 102 is coiled such that its top and bottom surfaces overlap. A dielectric 103 is coated or disposed on the surface of one electrode 102, such that the two electrodes 102 are separated by the dielectric 103 in the areas where the coiled member overlaps. The electrode surfaces may be separated by a flexible insulating substrate 160. When voltage is applied across the two electrodes 102, the top and bottom surfaces of the coil adhere and transmit forces that prevent relative displacement of the input and output connections. The electrodes 102 may be adhered to the carrier across their entire surface or only a portion. The carrier may comprise a single layer or multiple layers of thin sheet capable of transmitting mechanical load. These layers may be selectively adhered to one another to allow each layer to flex separate from one another or to allow for expansion or contraction of the total carrier thickness in the direction perpendicular to the axis of action of the linear clutch 100. The ends of the clutch member includes structural components capable of transmitting mechanical load. These structural components may have features for attachment to the structure of a greater device such as pin holes as shown or any other method of mechanical attachment such as attachment hardware like bolts, screws or rivets or clamps such as a split hub clamp or shaft collar. These structural elements may also feature a through bore for passage of other components such as shafts, rods or cables.

In some embodiments the compact linear clutch 100 may be mechanically attached to a Bowden cable. The Bowden cable housing may terminate on the clutch housing 140 or on a structure fixed in space relative to the stationary electrode 102.

FIG. 19 shows a telescoping compact clutch 100, which translate in a linear direction. A telescoping clutch 100 requires at least two separate clutch members of similar shape, but differing size such that one member can slide within the other with light contact or a small gap between surfaces. Each clutch member must contain at least one electrode 102. The electrode 102 may make up the bulk of the clutch member, or may be applied as an attachment, thin film or coating. A dielectric material 103 is disposed between the electrodes 102. The dielectric material 103 may be disposed on one or both electrodes 102 or it may be interposed between them. A layer or multiple layers of intermediate carriers may be disposed between the structure of the telescoping members and the electrode 102 such that limited movement of the electrode 102 surface perpendicular to the telescoping element is possible. This may be achieved by selectively adhering portions of the carrier such that the unsupported sections can flex in directions perpendicular to the telescoping action. In the engaged state, electrodes 102 on the inner diameter of a clutch interface and the outer diameter of the clutch interface must have an electric potential between them. Each clutch electrode 102 may be separable from the electrical circuit or held at different voltage potentials to enable all or only a subset of the clutch electrodes 102 to be engaged. The telescoping clutch members are shown as cylindrical, but may have a range of shapes including but not limited to square or rectangular. A cylindrical linear clutch 100 may allow a translational degree of freedom along the telescoping axis and a rotary degree of freedom about the telescoping axis. Other shapes may be utilized to limit the degrees of freedom of the clutch 100.

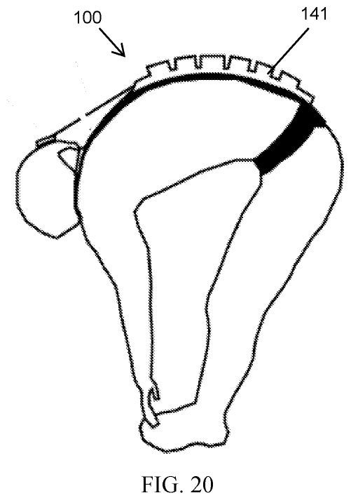

FIG. 20 shows an implementation of a flexible garter-style clutch 100 selectively connecting a harness waist strap through a tether to a helmet. In this embodiment, the flexible nature of the housing 140 allows less restricted movement of the user and also resists binding due to compression, for example when the user is sitting in a chair.

In some embodiments of the linear clutch 100, a sensor may be included internal or external to the clutch 100 to measure extension of the clutch and/or its associated joint in a greater device. This sensor may be an optical sensor, magnetic sensor, an electrical brush or spring finger contact interacting with a patterned conductive surface, or an inductive sensor. Signals from this sensor may be used to inform or control clutch 100 behavior. For example, greater voltage may be commanded nearer to the boundaries of the clutch 100 range of motion and less voltage may be applied near the center of its travel.

In some embodiments the clutch 100 may be activated in response to sensor data from accelerometers, pressure sensitive switches, IMUs accelerometers, biological sensors such as EMG sensors, optical sensors, encoders or others. The sensor provides data to a controller that controls clutch 100 behavior, and may also control a motor, linear actuator, or some other outputs. For example, movement of a linear platform that activates a pressure sensitive switch placed in a certain position could trigger the controller to activate the clutch 100, thus locking the linear platform in place.

The input base frame and output base frame can be connected to components external to the clutch 100 by a variety of methods including but not limited to: pressure sensitive adhesive, glue, welding, rivets, screws, bolts, pins, clamps, stitches, heat stakes, crimps, snaps, buckles, carabiners, hook and loop fasteners, or other methods. The base frames may be of a wide variety of constructions including the planar constructions depicted in several figures, or they may be more complex 3-dimensional components. The base frames may serve multiple purposes including but not limited to the housing of a greater device such as a robot.

Some embodiments may include a housing 140. The housing 140 may act in a number of capacities: to prevent compression between the input and output electrodes 102, to supply electrical isolation, to provide environmental protection, to aid in aesthetics, or some combination of the above. The housing 140 may include grommets or gaskets for environmental sealing. The housing 140 may be made of semi-flexible materials such as fiberglass, carbon fiber, spring steel or polymer sheet. Flexible standoffs may be used within the housing 140. A subset of housing components may be compressible in at least the direction perpendicular to the surfaces of the electrodes 102.

Each of the embodiments shown may be used in isolation or as a plurality. Each clutch 102 must include at least two electrodes 102, but may include any number of electrodes 102. Any embodiment of the compact linear electrostatic clutch 100 described herein may be used in pairs or in any plurality.

Electrical connection may be established between clutch electrodes 102 via wires, sliding electrical contacts, or by establishing electrical connection through tensioners 120 or otherwise conductive and deformable connections. In some embodiments the moving electrode 102 may not have an explicit electrical connection. These electrodes 102 are connected to the clutches circuit 170 through the dielectric material 103 disposed between the electrodes 102 as series capacitors. In the engaged state, these electrodes 102 are held at an intermediate voltage between the voltages of the adjacent electrodes 102.

A clutch 100 can be engaged by applying a voltage potential across its electrodes 100. The maximum force transmittable across the clutch 100 is determined by the magnitude and wave form of the applied voltage, the area of clutch interface, the thickness and material content of the dielectric layer 103. The slipping force of the linear clutch 100 can be adjusted by modulating the applied voltage magnitude, frequency of the waveform. Holding force trends with voltage squared at voltages above 10 volts and below the breakdown voltage of the dielectric material 103. The transmittable force may be adjusted by altering the number of clutch members that are engaged in parallel. Whether clutch members is engaged with a voltage difference across it, disengaged with equal electrical potentials on each electrode 102, or floating may be controlled using switches, MOSFETs, transistors or other electrical components.

When used in this specification and claims, the terms “comprises” and “comprising” and variations thereof mean that the specified features, steps, or integers are included. The terms are not to be interpreted to exclude the presence of other features, steps or components.

The invention may also broadly consist in the parts, elements, steps, examples and/or features referred to or indicated in the specification individually or collectively in any and all combinations of two or more said parts, elements, steps, examples and/or features. In particular, one or more features in any of the embodiments described herein may be combined with one or more features from any other embodiment(s) described herein.

Protection may be sought for any features disclosed in any one or more published documents referenced herein in combination with the present disclosure. Although certain example embodiments of the invention have been described, the scope of the appended claims is not intended to be limited solely to these embodiments. The claims are to be construed literally, purposively, and/or to encompass equivalents

What is claimed is:

1. An electrostatic clutch comprising:
a first electrode;
a second electrode;
a dielectric material disposed between the first electrode and the second electrode;
an input connection member associated with at least one of the first electrode and the second electrode; and
an output connection member associated with the second electrode or the dielectric material,
wherein displacement of the input connection member relative to the output connection member does not result in a change in the overlap area of the first electrode and the second electrode.

2. The clutch of claim 1, further comprising a winding device attached to the first electrode or the second electrode, wherein the winding device comprises a roller, spool, or pulley.

3. The clutch of claim 2, further comprising a belt having a friction surface.

4. The clutch of claim 3, wherein the belt consists of the input connection member or the output connection member, wherein one or more of the first electrode and the second electrode is coplanar with the friction surface of the belt.

5. The clutch of claim 3, wherein the belt consists of the input connection member or the output connection member, wherein one or more of the first electrode and the second electrode is attached to the belt at a surface that is opposite the friction surface.

6. The clutch of claim 1, wherein the output connection member comprises a shuttle.

7. The clutch of claim 2,
wherein at least one of the first electrode and the second electrode wraps around the winding device,
wherein the second electrode is configured with a 180 degree turn around at least one roller attached to the input connection member, and
wherein the second electrode wraps around one or more additional moving rollers that are attached to one or more tensioners.

8-12. (canceled)

13. The clutch of claim 7, wherein the second electrode is coiled around the winding device attached to the input connection member.

14. (canceled)

15. The clutch of claim 13, wherein the output connection member comprises a cable wrapped around an output winding device.

16. The clutch of claim 15, wherein the second electrode also coils around the winding device that is wrapped by the output connection member.

17. The clutch of claim 1, wherein the output connection member comprises a cable that terminates on a second link that makes a rotary joint connection to a first link attached to the input connection member to direct torque at the rotary joint.

18. The clutch of claim 1, wherein the input connection member connects to the first electrode and the second electrode, wherein the output connection member connects to the dielectric material.

19. The clutch of claim 1, further comprising a flexible housing comprising a shuttle guide and a spacer such that compression of the housing does not cause friction between the first electrode, the second electrode, or the dielectric material.

20. (canceled)

21. The clutch of claim 1, wherein one or both of the input connection member and the output connection member is a belt, timing belt, toothed belt, v-belt, or other flexible connector.

22. (canceled)

23. The clutch of claim 21, wherein a belt interfaces with a second link that makes a rotary joint connection to a first link attached to the input connection member, allowing the clutch to effectively produce torque at the rotary joint.

24. The clutch of claim 23, wherein the input connection member comprises a surface of the first link.

25. The clutch of claim 23, wherein the input connection member comprises a third member in proximity to the first link or the second link.

26-30. (canceled)

31. The clutch of claim 17, wherein multiple clutches produce different torque in different directions or magnitudes about the rotary joint.

32. An electrostatic clutch comprising:
a first electrode;
a second electrode;
a dielectric material disposed between the first electrode and the second electrode;
an input connection member;
an output connection member; and
an electrically insulating flexible substrate disposed between the first electrode and the second electrode,
wherein the clutch is coiled such that a voltage applied across the first electrode and the second electrode causes a change in friction between an overlapping area between the first electrode and the second electrode causing resistance to relative translation or rotation of the input connection member and the output connection member.

33. An electrostatic clutch comprising:
a first electrode;
a second electrode;
a dielectric material disposed between the first electrode and the second electrode;
an input connection member which includes a hollow mechanical feature;
an output connection member which includes a matching positive mechanical feature of a size equal to or smaller than the input connection member hollow mechanical feature and that is positioned inside the hollow mechanical feature of the input connection member,
wherein applying a voltage across the first electrode and the second electrode causes resistance to relative rotation of the mechanical features about a common axis, and/or causes resistance to relative translation of the mechanical features along the common axis.
